(19) United States
(12) Patent Application Publication
(10) Pub. No.: US 2008/0110351 A1
(43) Pub. Date: May 15, 2008

(54) Holding device of a household grilling appliance

(75) Inventors: Hans-Jurgen Bauer, Traunstein (DE); Franz Gschwendner, Neukirchen am Teisenberg (DE); Ramona Haberkamm, Traunreut (DE); Jorg Rosenbauer, Nussdorf (DE); Markus Theine, Freilassing (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 11/983,508

(22) Filed: Nov. 8, 2007

(30) Foreign Application Priority Data
Nov. 10, 2006 (DE) 10 2006 053 077.2

(51) Int. Cl. A47J 37/04

(52) U.S. Cl. 99/421 H

(57) ABSTRACT

The holding device (2) is formed from brackets (3) which can be inserted into the item to be cooked (1) and from a handle (8) in each instance.

According to the invention, the at least one bracket (3) comprises a handle (8) which protrudes radially on all sides in one piece across the bracket. The handles (8) have a polygonal peripheral edge (8) which protrudes across the bracket (3).

The invention relates to a holding device of a household grilling appliance for an item to be cooked, which can be rotated about a grilling axis in respect of a radiation heating element in the cooking operation and comprises at least one bracket holding the item to be cooked and preferably insertable therein and a handle for its removal from the grilling appliance.

With a known apparatus for a rotatable item to be grilled (FR-PS 1 104 559), the item to be grilled is mounted in a lockable lattice casing or between two gratings, which are mounted in a rotatable fashion in a mounting frame using two-sided axis attachment pieces and can be rotated in different grilling positions by means of a handle attached to one side of one of the axis attachment pieces. Alternatively, the gratings are connected by way of shafts present in pairs instead of a rotatable axis attachment pieces to polygonal hexagonal adjustment flanges arranged on both sides in each instance and surrounding the item to be grilled on all sides, whereby the item to be grilled can be positioned in six grilling positions in respect of a heating source.

Even with a further holding device for holding items to be cooked in different positions (DE-PS 657 089), polygonal adjustment flanges are provided on both sides of the item to be cooked which is pierced by a dual spit, said polygonal adjustment flanges being provided with coaxial bearing bushes for the two arms of the dual spit.

The object underlying the present invention is to configure a holding device of the type mentioned at the start such that it can be used as an autonomously driven unit or in conjunction with a mounting unit and/or with a motorized rotary drive system in the case of items to be cooked with different weights, in particular taking into consideration the operation thereof within spatially cramped treatment compartments of household grilling appliances, such as for instance cooker cavities of household ovens or household cookers.

The object posed is achieved in accordance with the invention in that the at least one bracket comprises a handle which protrudes radially on all sides in one piece across the bracket.

The structural unit comprising a bracket and handle produces different applications of the holding device, namely with or without spit axes (real or virtual spit axes) which wholly or partially pierce the item to be cooked and this occurring irrespective of the axial extension of the item to be cooked with a handle and/or handles which is/are positioned close to the item to be cooked. The handle protruding radially on all sides across the bracket produces a more secure and easily achievable operation of the holding device during use, during removal and during rotation of the holding device into and/or out of and/or in the household grilling device, e.g. in the oven cavity of a oven, in particular with larger items to be cooked, whereto the holding device can be clasped using both hands protected with gloves for instance.

The aforementioned unit comprising a handle/bracket can be advantageously configured such that a bracket with a handle is provided in each instance on a virtual or real spit axis on both sides of the item to be cooked. Each unit can comprise a short spit axis or can be connected on both sides of the item to be cooked to the item to be cooked by means of fork prongs arranged coaxially to the spit axis or by means of fork clamps, or can be attached to a real spit axis which pierces the item to be cooked, with it being advantageous if, according to a further embodiment, the holding device is mounted to a mounting frame in a detachable fashion using the mounting axes of a spit axis which pierces the item to be cooked and is present on both sides of the item to be cooked or using the bracket. In this way, the holding device e.g. the spit axis can be connected to a motorized drive, or as mentioned, can be manually rotated in different grilling positions.

According to a further embodiment of the invention, each unit consisting of a bracket and handle comprises a bearing bush which is integrated in said unit and protrudes axially outwards i.e. away from the item to be cooked, for the spit axis, the free ends of which extend in a stop-restrictive fashion as far as the mounting elements of the mounting frame. A predetermined position of the item to be cooked which remains constant during each grilling process in the mounting frame is thus ensured at a safe distance of the holding device and thus the handles from the mounting elements of this mounting frame.

Further advantageous details of the invention result from the exemplary embodiment illustrated in the drawing and described below, in which;

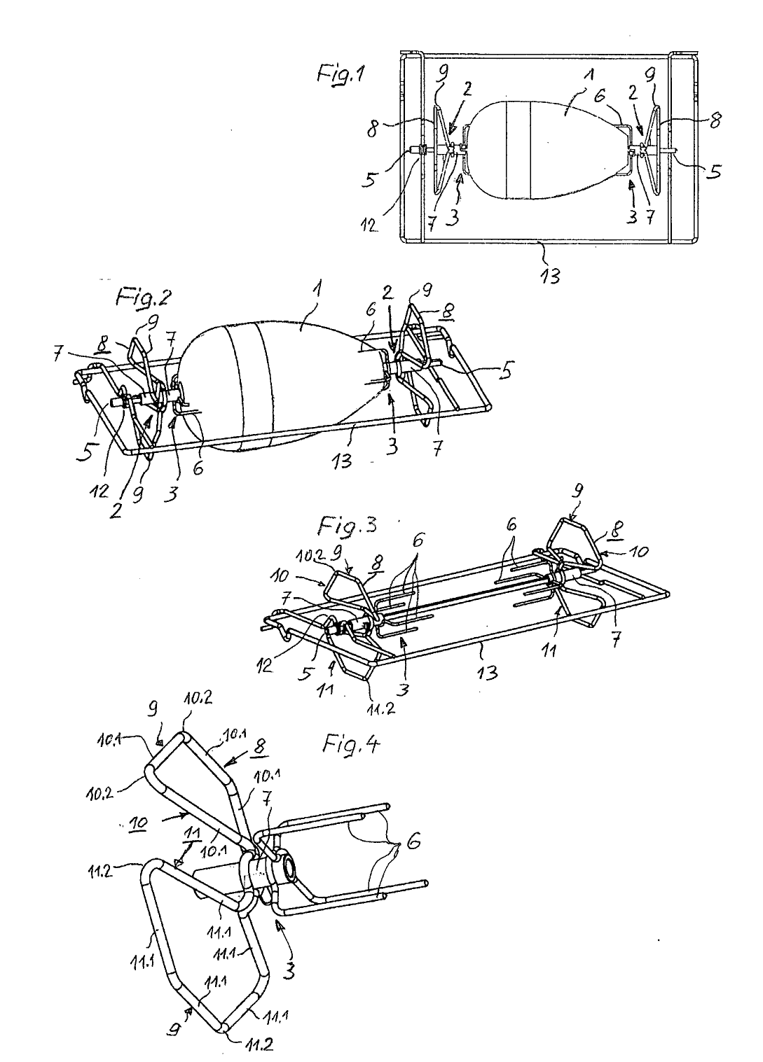

FIG. 1 shows the plan view onto the holding device with mounting frame,

FIG. 2 shows a detailed perspective view of the holding device,

FIG. 3 shows the holding device without an item to be cooked, i.e. in view of the fork prongs inserted into the item to be cooked according to FIG. 1,

FIG. 4 shows an enlarged detailed view of the holding device according to the preceding figures.

FIGS. 1 and 2 show an item to be cooked 1 or an item to be grilled, e.g. an American-sized turkey, held in a holding device 2, which consists of at least a bracket 3 in the form of a rod-like structure with fork prongs 6 running coaxially in respect of a spit axis 5, said fork prongs 6 being inserted into the item to be cooked 1 and thus being coupled. The remaining FIGS. 3 and 4 show that each of the two holding devices 2 arranged on both sides of the item to be cooked 1 exhibit the aforementioned spit-like bracket 3, which can be formed from two clamp-like holding clamps which clasp the item to be cooked 1 on the outer sides. Each holding device 2 is connected in one piece to a handle 8 by way of a bearing bush 7, said handle 8 being formed from two rod-like gripper elements 10 and 11 fastened to the axial bearing bush 7 and forming the polygonal hexagonal peripheral edge 9 of the handle 8 shown as a half in the exemplary embodiment, (FIG. 3, 4), from which the gripper element 10, 11 comprises three circumferential and straight adjusting sections 10.1, 11.1 with four corner segments 10.2, 11.2, with each two corner segments 10.2, 11.2, being distanced from another at intervals from the remaining adjusting sections 10.1, 11.1 and together forming an adjusting section of the hexagon. The polygonal peripheral edge 9 of each bracket 3 considerably overlaps the spit axis 5 as well as the bracket 3 and forms the handle 8, which is connected to the item to be cooked 1 by way of the associated brackets 3 and with which a heavy item to be cooked can be removed from a cramped grilling container using both hands, inserted therein and moved into different grilling positions. As shown in the Figures, the sections 10.1, 11.1 coming directly from the bearing bush 7 are bent outwards angled away from the item to be cooked 1, whereupon a constructively favorable close proximity between the bracket 3 and the handle 8 is achieved on the one hand, and the peripheral edge 9 or gripping edge is however relatively remote from the item to be cooked 1 in the axial direction.

The aforementioned bearing bush 7 of each structural unit 3/8 extends over the inner extensions of the bracket 3 which are bent around the bearing bush 7 as far as the stop-restrictive attachment on mounting elements 12 of a rod-like mounting frame 13, which can rest on a support surface (not shown) or is part of a drive system for the holding device 1 and supports a real spit axis which pierces the item to be cooked 1 on the axis ends using the eye-like mounting elements 12. The mounting elements 12 of the holding frame 13 are open upwards so that a real spit axis 5 can be inserted into these mounting elements 12. The real spit axis 5 pierces the item to be cooked 1 and serves, where it protrudes at both ends, as a mounting for the two bearing bushes 7 with their brackets 3 and handles 8.

1-8. (canceled)

9. A holding device of a household grilling appliance for an item to be cooked such that the item to be cooked can be rotated about a grilling axis with respect to a radiation heating element during the cooking operation, the holding device comprising:
a.) a first bracket holding the item to be cooked and preferably being at least partially insertable into the item to be cooked to facilitate retention of the item to be cooked by the first bracket; and
b.) a first handle coupled to the first bracket, the first handle protruding as a single piece radially outwardly from the first bracket on substantially all sides therearound.

10. The holding device as claimed in claim 9 and further comprising a second handle coupled to a second bracket, the second handle protruding as a single piece radially outwardly from the second bracket on substantially all sides therearound, the first bracket and the second bracket being operable to engage an item to be cooked at respective axially spaced sides thereof as viewed relative to the grilling axis, and the first handle and the second handle being positioned such that a user can grip the holding device via the handles on both axially spaced sides of the item to be cooked.

11. The holding device as claimed in claim 10, wherein the holding device is operable to be mounted in a detachable manner on a mounting frame and the holding device has, on both sides of the item to be cooked, mounting portions through which the grilling axis extends.

12. The holding device as claimed in claim 11 and further comprising a first bearing bush operatively associated with the first bracket and the first handle and a second bearing bush operatively associated with the second bracket and the second handle, the first bearing bush and the second bearing bush each protruding axially freely outwardly away from the item to be cooked and each having a free end that extends in a stop-restrictive manner as far as the mounting elements of the mounting frame on which the holding device is mounted.

13. The holding device as claimed in claim 10, wherein each handle has a polygonal peripheral edge protruding over the respective associated bracket.

14. The holding device as claimed in claim 11, wherein each handle consists of two gripping elements formed of a rod-like material and forming half of a peripheral edge of the respective handle and fastened to the respective bearing bush.

15. The holding as claimed in claim 10, wherein each bracket includes a plurality of fork prongs that can be inserted into the item to be cooked and are arranged coaxially with respect to the grilling axis.

16. A household grilling appliance comprising:
a.) a radiation heating element for applying radiation heating to an item to be cooked during a cooking operation; and
b.) a holding device for releasably retaining an item to be cooked such that the item to be cooked can be rotated about a grilling axis with respect to the radiation heating element during a cooking operation, the holding device having a first bracket holding the item to be cooked and preferably being at least partially insertable into the item to be cooked to facilitate retention of the item to be cooked by the first bracket and a first handle coupled to the first bracket, the first handle protruding as a single piece radially outwardly from the first bracket on substantially all sides therearound.

17. A holding device of a household grilling appliance for an item to be cooked, the holding device comprising:
a.) an item bracketing element operable to hold an item to be cooked, the item bracketing element having a first retention component for releasably engaging to the item to be cooked at a first item location thereon, the first retention component engaging the item to be cooked while the item to be cooked is moved about a cooking axis at a predetermined spacing relative to a radiation heating element during a cooking operation; and
b.) a handle coupled to the item bracketing element, the handle having a first portion that extends radially outwardly relative to the cooking axis and a second portion that extends radially outwardly relative to the cooking axis, the first portion of the handle forming a gripping element by which a user can manually engage the handle and the second portion of the handle forming a gripping element by which a user can manually engage the handle at a location angularly offset from the location at which a user can manually engage the first portion of the handle.

18. The holding device of a household grilling appliance according to claim 17 and further comprising a second retention component for releasably engaging the item to be cooked at a second item location thereon that is spaced from the first item location and the first retention component and the second retention component cooperating with one another to retain therebetween the item to be cooked while the item to be cooked is moved about the cooking axis at a predetermined spacing relative to a radiation heating element during a cooking operation.
